(19) United States
(12) Patent Application Publication
(10) Pub. No.: US 2014/0233080 A1
(43) Pub. Date: Aug. 21, 2014

(54) Multi-Beam ROS Imaging System

(71) Applicant: XEROX CORPORATION, Norwalk, CT (US)

(72) Inventor: Steven R. Moore, Pittsford, NY (US)

(73) Assignee: Xerox Corporation, Norwalk, CT (US)

(21) Appl. No.: 13/769,251

(22) Filed: Feb. 15, 2013

(51) Int. Cl. G02B 26/10

(52) U.S. Cl. CPC G02B 26/101
USPC 359/204.1

(57) ABSTRACT

A multiple-beam imager includes multiple light sources (e.g., laser diodes) that transmit light beam pulses (energy doses) along parallel paths onto print plate spots disposed in a circumferential target region during each imaging period. The beam pulses are coordinated with rotation of the imaging cylinder such that, as a selected print plate spot is rotated through the target region, it is sequentially positioned during successive imaging periods to receive light beam pulses from each of the sequentially-aligned light sources, whereby the selected print plate spot receives multiple energy doses (e.g., one during each raster-scan) as it passes through the target region, thereby gradually heating and then evaporating the fountain solution predisposed over the selected print spot. A polygon mirror is used to raster-scan the beam pulses along parallel raster-scan zones.

### FIELD OF THE INVENTION

This invention relates to imaging systems, and more particularly to raster-output-scanner imaging systems utilized, for example, in printing systems.

### BACKGROUND OF THE INVENTION

FIG. 8 is a simplified cross-sectional view showing a generalized conventional printing system that utilizes an imaging system including an imaging cylinder having a cylindrical print plate. The print plate is dampened with a uniform thin film of fountain solution (FS). Next, a high power modulated light source is used to selectively vaporize the FS where image content is destined. Not shown but known to be critical is a suction manifold in close proximity to the imaging zone to remove the FS vapor cloud that forms before it can interfere with the imaging process. Next, the plate passes through an inker nip, and the exposed portions of the plate are coated with ink. If needed, an ultraviolet (UV) lamp is used to partially cure the ink on the print plate in order to enhance its transfer off the print plate. Next, the ink is transferred from the print plate to a print media (e.g., bond paper) via a pressure transfer nip. Finally, if transfer efficiency of the ink is not 100%, a cleaning system removes all residual ink from the print plate, and the process is then repeated.

FIG. 9 is a simplified perspective view showing a conventional single-beam Raster Output Scanner (ROS) imaging system including a single high-powered laser source, imaging optics, and a rotating polygon mirror that are utilized to produce the high-powered modulated light directed onto the print plate of an imaging cylinder. A modulated laser beam generated by the laser (light) source is directed through the imaging optics onto the polygon mirror, whereby the incident beam is reflected by each mirror facet along a range of outgoing beam angles as the polygon mirror rotates around its central axis, thereby raster-scanning the outgoing modulated beam along a substantially longitudinal scan path on the cylindrical print plate. This longitudinal scan path is repeated as each mirror facet rotates into position to receive the incident laser beam. By coordinating the rotating speeds of polygon mirror and imaging cylinder such that each raster-scan (i.e., the scan path generated by each mirror facet) begins at successively incremental circumferential edge regions of the print plate, and by modulating the laser such that each edge region receives either a beam pulse, the imaging system facilitates production of two-dimensional images on the print plate of the imaging cylinder.

A problem with the conventional imaging single-beam ROS imaging system described above is that, in order to deliver sufficient energy to the print plate within the very short dwell time of the raster beam (i.e., to achieve high page-per-minute printer speeds, a very high energy laser source (e.g., on the order of a KiloWatt or more) is required. That is, a limiting characteristic of the conventional system is the power necessary to evaporate the FS from the print plate, which may be water-based. The high latent heat of vaporization of water, however, entails that large amounts of power are required. As an example, for a one color 24″ wide process running at 2 m/s, a minimum incident power delivery from the imager must be 6.3 KW to evaporate a 2 μm thick water film. Manufacturing such an imager using a single laser light source is prohibitively expensive, and potentially dangerous in the event of accident in which the laser light escapes the printer containment.

What is needed is an imaging system that both facilitates very high page-per-minute printer speeds and avoids the use of very high powered lasers.

### SUMMARY OF THE INVENTION

The present invention is directed to a multiple-beam imager including an array of light sources (e.g., laser diodes) that are arranged to transmit light beam pulses (energy doses) along parallel paths onto a targeted group of print plate spots (i.e., unit regions of an imaging cylinder print plate that are disposed in a circumferential target region during a given imaging period). The light sources are controlled to generate the light beam pulses in coordination with rotation of the imaging cylinder such that, as each print plate spot is rotated through the target region, it is sequentially positioned during successive imaging periods to receive light beam pulses from each of the sequentially-aligned light sources. For example, during an initial imaging period, when a selected print plate spot is aligned with a first beam path, a first light source is actuated to transmit a first beam pulse along the first beam path onto the selected print spot, thereby transferring a first energy dose to the selected print plate spot. During a subsequent imaging period, when the selected print plate spot is aligned with an adjacent second beam path, a second light source is actuated to transmit a second beam pulse along the second beam path onto the selected print spot, thereby transferring a second energy dose to the selected print plate spot. This process is repeated as the selected print spot is aligned with the beam path of each light source, whereby the selected print plate spot receives multiple energy doses as it passes through the target region. Accordingly, the present invention facilitates the removal of fountain solution from cylindrical print plate using a series of relatively low-power beam pulses that are applied to each targeted spot during each revolution of the imaging cylinder, whereby the fountain solution is gradually heated up to its evaporation temperature by multiple relatively low-energy doses (i.e., in comparison to being removed by a single high-powered beam pulse, as used conventional systems). By utilizing multiple beam pulses that are sequentially applied to a targeted spot as the spot is rotated through the elongated target region, the present invention facilitates both the use of low power lasers and higher printing speeds.

### BRIEF DESCRIPTION OF THE DRAWINGS

These and other features, aspects and advantages of the present invention will become better understood with regard to the following description, appended claims, and accompanying drawings, where:

FIG. 1 is a side view showing an imaging system according to a simplified embodiment of the present invention;

FIGS. 2(A), 2(B), 2(C) and 2(D) are side views showing the imaging system of FIG. 1 during operation;

FIG. 3 is a graph showing temperature changes incurred by a portion of the fountain solution during the operational periods depicted in FIGS. 2(A) to 2(D);

FIG. 4 is a perspective view showing an imaging system according to a second embodiment of the present invention;

FIG. 5 is a top view showing a portion of the imaging system of FIG. 4;

FIGS. 6(A), 6(B), 6(C) and 6(D) are top views showing a portion of the imaging system of FIG. 4 during operation;

FIG. 7 is a simplified diagram showing a printing system incorporating the imaging system of FIG. 4 according to another embodiment of the present invention;

FIG. 8 is a side view diagram depicting a conventional printing system; and

FIG. 9 is a top view diagram depicting a conventional raster-type imaging system.

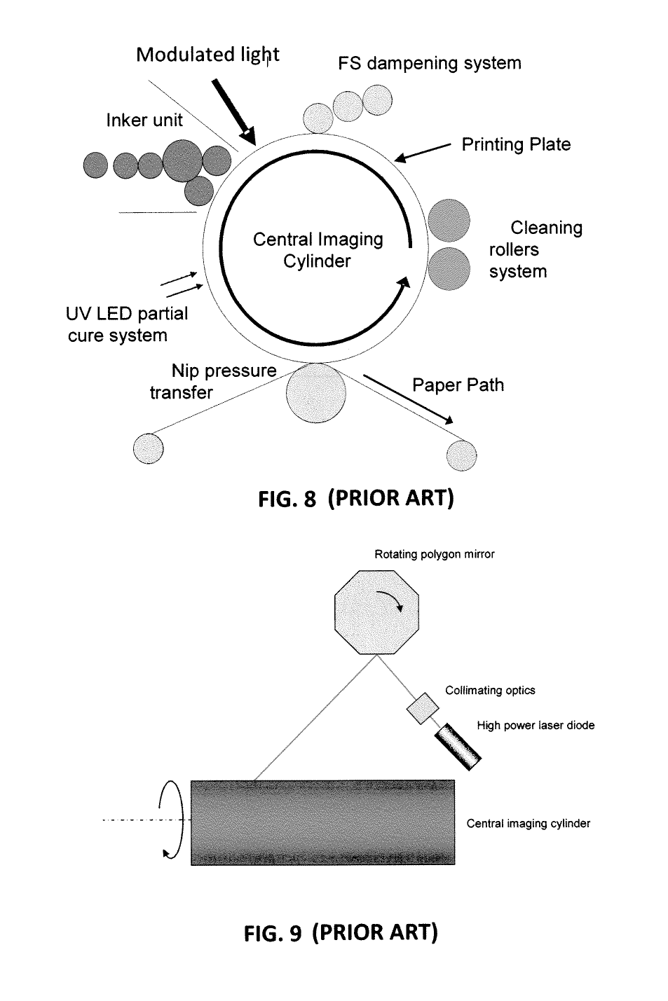

### DETAILED DESCRIPTION OF THE DRAWINGS

The present invention relates to an improvement in imaging systems that are utilized, for example, in printing systems. The following description is presented to enable one of ordinary skill in the art to make and use the invention as provided in the context of a particular application and its requirements. As used herein, directional terms such as “upper”, “upwards”, “lower”, “downward”, “front”, “rear”, are intended to provide relative positions for purposes of description, and are not intended to designate an absolute frame of reference. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

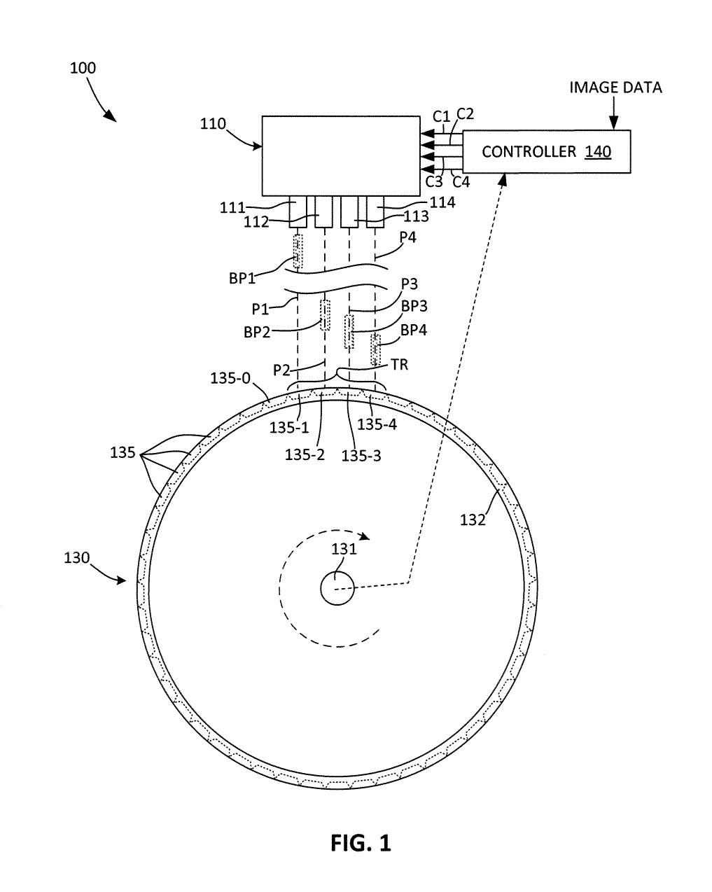

FIG. 1 is a side view showing a simplified multiple-beam imaging system 100 according to a generalized embodiment of the present invention. Imaging system 100 generally includes an illuminator 110 for producing light beam pulses BP1 to BP4 that directed along corresponding beam paths P1-P4, an imaging cylinder 130 that is positioned to receive light beam pulses BP1 to BP4, and a system controller 140 for controlling illuminator 110 in coordination with rotation of imaging cylinder 130.

As indicated at the top of FIG. 1, illuminator 110 includes four light sources (e.g., laser diodes) 111 to 114 that are arranged, for example, in a linear manner such that beam paths P1-P4 are parallel, and such that beam pulses BP1 to BP4 are respectively directed onto respective separate regions of an elongated target region TR. According to an aspect of the invention, each light source 111 to 114 is independently controllable, e.g., by way of separate control signals C1 to C4, such that any combination of light sources 111 to 114 is activated at a given time.

Referring to the lower portion of FIG. 1, imaging cylinder 130 is a conventional structure that is rotated around a central axis 131 and including a cylindrical print plate 132 composed of a suitable material (e.g., silicone). Cylindrical print plate 132 defines multiple discrete print plate regions 135, which are referred to herein as “print plate spots” or simply “spots”, that are disposed end-to-end around the circumference of cylindrical print plate 132. Those skilled in the art understand that spots 135 do not correspond to fixed regions of the print plate, but instead are defined during operation of an optical system by the print plate locations upon which light energy is deposited, for example, to remove fountain solution disposed thereon. However, for purposes of simplifying the following explanation, print plate spots 135 are depicted as being fixed regions of cylindrical print plate 132.

As indicated at the top of imaging cylinder 130, four print plate spots (e.g. spots 135-1 to 135-4) are disposed in target region TR during each sequential time period referred to herein as an “imaging period”, where each imaging period corresponds to a single raster-scan period in an ROS imaging system. The four print plate spots located in target region TR during a given imaging period are referred to herein as a “targeted group” because each of the four print plate spots is aligned with a corresponding beam path P1 to P4, and as such are positioned to receive (or not receive) beam pulses (energy doses) transmitted along beam paths P1 to P4. For example, during the imaging period depicted in FIG. 1, if light source 111 is activated to produce beam pulse BP1, then beam pulse BP1 is transmitted along beam path P1 onto spot 135-1. Similarly, if activated during the depicted imaging period, light source 112 transmits beam pulse BP2 along beam path P2 onto spot 135-2, light source 113 transmits beam pulse BP3 along beam path P3 onto spot 135-3, and light source 114 transmits beam pulse BP4 along beam path P4 onto spot 135-4. Note that, because imaging cylinder 130 is rotating at a constant speed, one spot (e.g., spot 135-4) rotates out of target region TR and one new spot (e.g., spot 135-0) rotates into target region TR during each sequential imaging period.

According to another aspect of the present invention, controller 140 is operated in accordance with externally supplied image data to control light sources 111 to 114 in coordination with the rotation of imaging cylinder 130 such that beam pulses BP1 to BP4 are sequentially transmitted to each selected print plate spot (i.e., spots 135 identified by the image data as requiring imaging), whereby each such selected spot receives multiple energy doses as the selected spot is rotated through target region TR (i.e., during a portion of a single revolution of imaging cylinder 130).

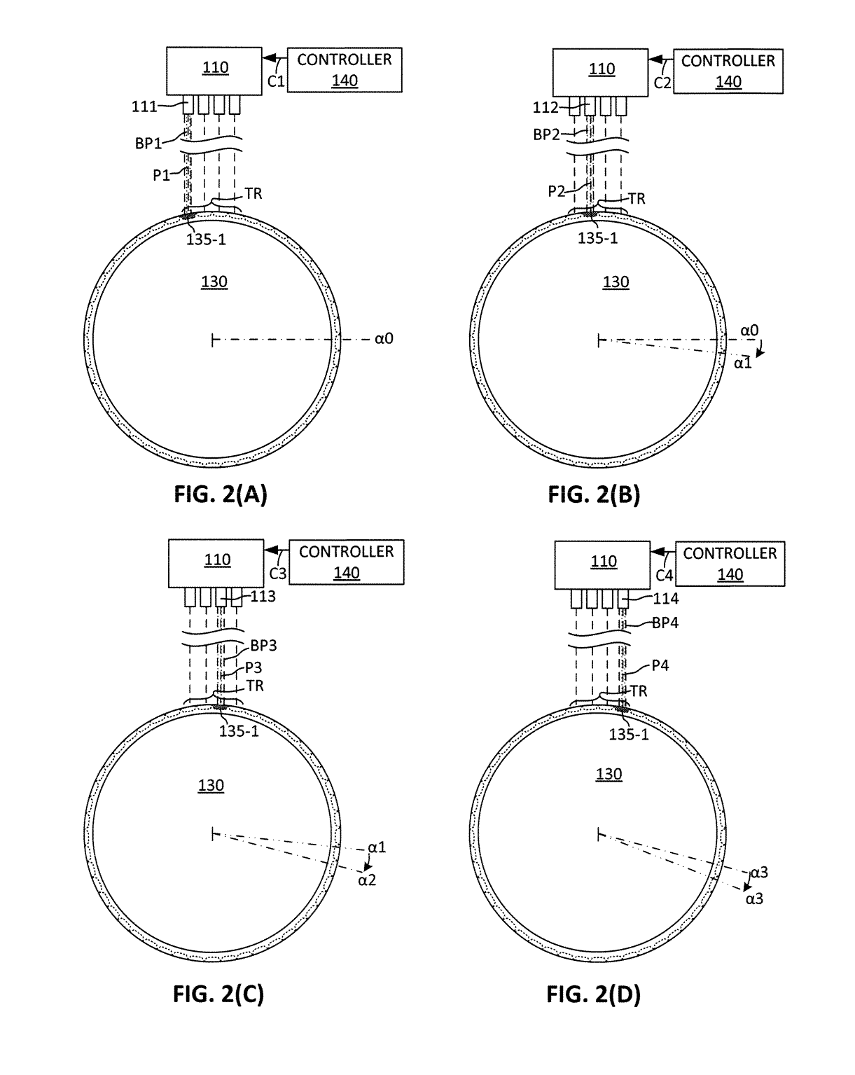

FIGS. 2(A) to 2(D) depict system 100 during a simplified example illustrating the sequential transmission of beam pulses onto spot 135-1 as it rotates through target region TR.

FIG. 2(A) shows imaging cylinder 130 in an initial rotational position α0 during a first imaging period when spot 135-1 is aligned with beam path P1 (i.e., shortly after spot 135-1 rotates into target region TR). At this time light source 111 is activated (e.g., by way of control signal C1 transmitted from controller 140) such that a first beam pulse BP1 is transmitted along beam path P1 onto spot 135-1. Spot 135-1 thus receives a first energy dose transmitted by way of beam pulse BP1.

FIG. 2(B) shows system 100 during a second imaging period that occurs a short time after the first imaging period. Imaging cylinder 130 has now rotated an incremental radial distance from initial (first) rotational position α0 to a (second) rotational positional, whereby spot 135-1 is now aligned with beam path P2 near the center of target region TR. Light source 112 is now activated (e.g., by way of control signal C2 transmitted from controller 140) such that a second beam pulse BP2 is transmitted along beam path P2 onto spot 135-1. Spot 135-1 thus receives a second energy dose transmitted by way of beam pulse BP2.

FIG. 2(C) shows system 100 during a third imaging period that occurs a short time after the second imaging period. Imaging cylinder 130 has now rotated an incremental further radial distance from (second) rotational positional to a (third) rotational position α2, whereby spot 135-1 is now aligned with beam path P3 at a position just past the halfway point of target region TR. Light source 113 is now activated (e.g., by way of control signal C3) such that a third beam pulse BP3 is transmitted along beam path P3 onto spot 135-1. Spot 135-1 has now received three energy doses transmitted by way of beam pulses BP1, BP2 and BP3.

FIG. 2(D) shows system 100 during a fourth imaging period when imaging cylinder 130 has rotated incrementally from (third) rotational position α2 to a (fourth) rotational position α4, whereby spot 135-1 is now aligned with beam path P4 at a position near the end of target region TR. Light source 114 is now activated (e.g., by way of control signal C4) such that a fourth beam pulse BP4 is transmitted along beam path P4 onto spot 135-1. Spot 135-1 has now received four energy doses transmitted by way of beam pulses BP1, BP2, BP3 and BP4.

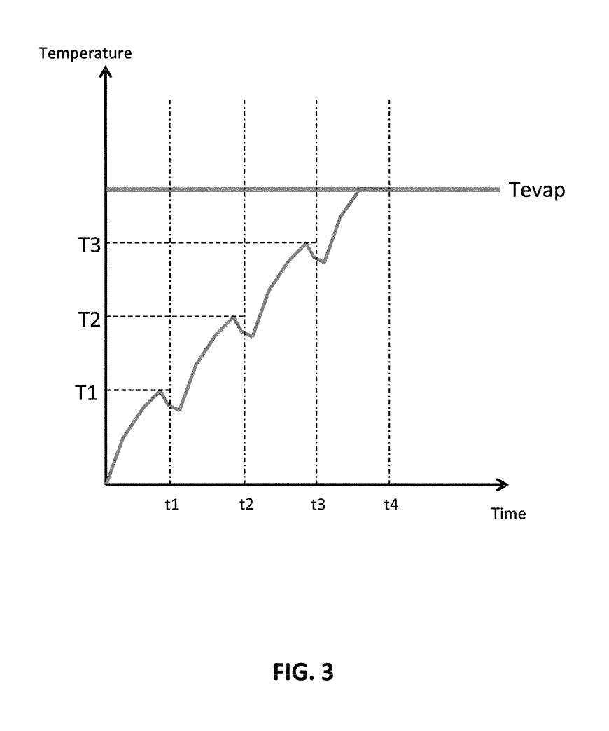

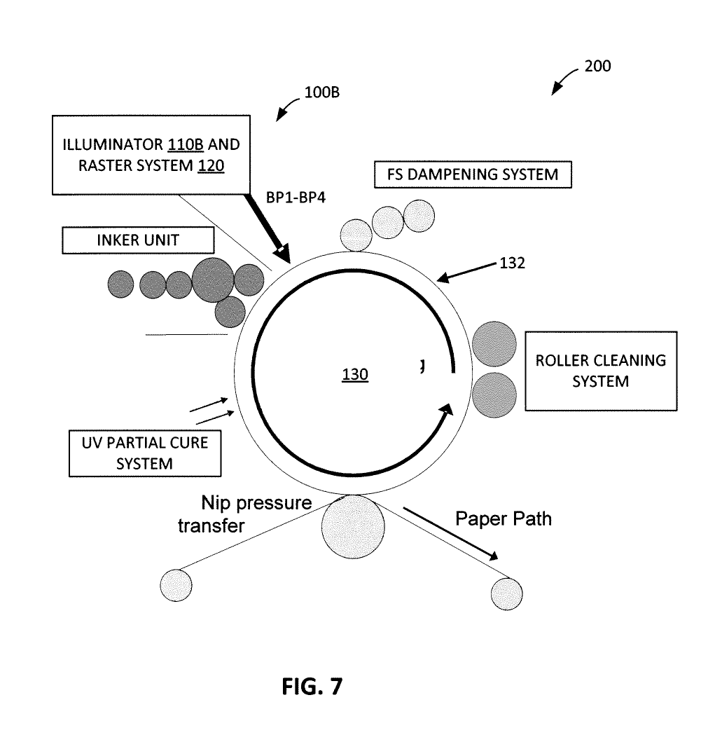

FIG. 3 is a graph that provides an example of how the present invention is utilized to remove a fountain solution portion from an associated spot during the four part imaging process depicted in FIGS. 2(A) to 2(D). A uniform fountain solution layer FS is formed on the surface of print plate 132 utilizing known techniques (e.g., as described above with reference to FIG. 8) before spot is rotated into the target region. FIG. 3 also shows that after the first imaging period t1 (i.e., after spot 135-1 receives beam pulse BP1 as described above with reference to FIG. 2(A)), the temperature of fountain solution FS-1 has increased to temperature T1 over spot 135-1. FIG. 3 further shows that at time t2, after receiving beam pulse BP2 (see FIG. 2(B)), spot 135-1 is further heated and the temperature of fountain solution FS-1 has increased to temperature T2 over spot 135-1. FIG. 3 further shows that at time t3, after receiving beam pulse BP3 (see FIG. 2(C)), spot 135-1 is further heated and the temperature of fountain solution FS-1 has increased to temperature T3 over spot 135-1. Finally, as shown in FIG. 3, by time t4, the fountain solution evaporation temperature Tevap has been reached and spot 135-1 is entirely free of fountain solution after receiving beam pulse BP4 (see FIG. 2(D)). Note that, in the present example, fountain solution layer FS remains over all other spots adjacent to spot 135-1 because these spots were not selected for processing by the imaging data/controller.

As illustrated by the above example, system 100 facilitates the removal of fountain solution from spot 135-1 on cylindrical print plate 132 using a series of relatively low-power beam pulses BP1 to BP4 that are applied during four imaging periods as spot 135-1 passes through target region TR a single time (i.e., during a single revolution of the imaging cylinder), whereby the fountain solution is gradually heated by multiple relatively low-energy doses. By utilizing multiple beam pulses BP1 to BP4 that are sequentially applied to spot 135-1 as spot 135-1 is rotated through target region TR, the present invention facilitates both the use of low power laser diodes and higher printing speeds.

Although it is possible to construct imaging system 100 using a two-dimensional array of laser diodes that simultaneously perform the imaging process described above along the entire length of an imaging cylinder, currently such a laser diode array would be impractically expensive. It is therefore presently preferable to perform the imaging process of the present invention using a Raster Output Scanner (ROS) imaging arrangement, which reduces overall system costs by allowing the imaging process to be performed using a single (e.g., linear) array of laser diodes.

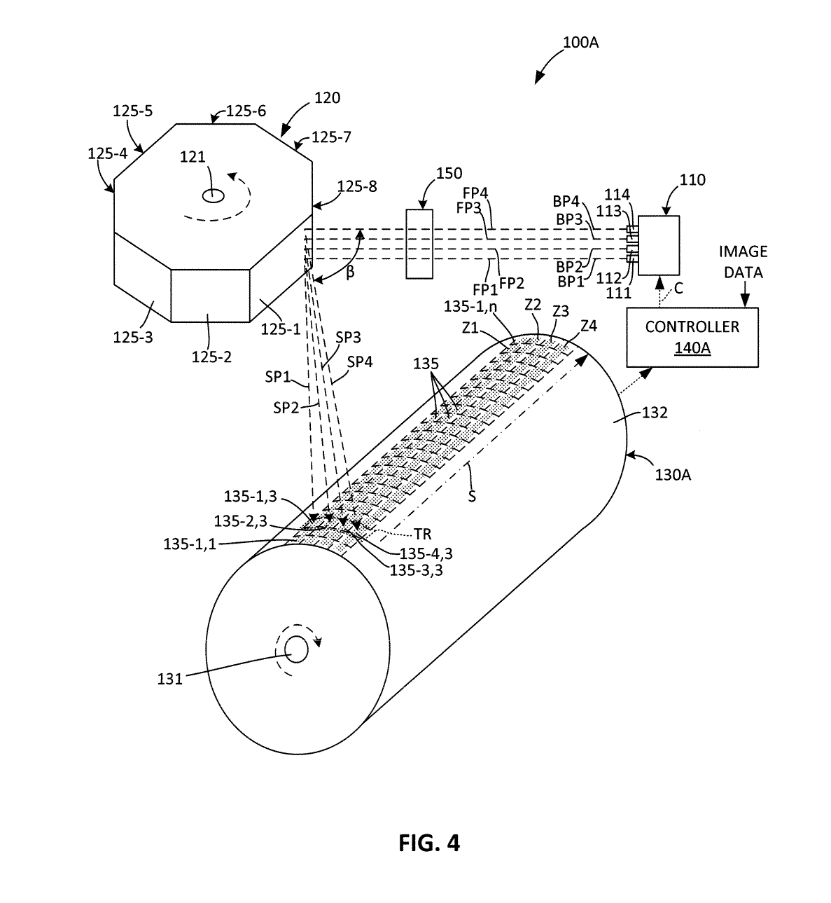

FIG. 4 is a perspective view showing a ROS imaging system 100A according to a second embodiment of the present invention. Imaging system 100 includes illuminator 110 and imaging cylinder 130 from the first embodiment (described above), and also includes a polygon mirror 120 and associated controller 140A.

Polygon mirror 120 is utilized to reflect beam pulses BP1-BP4 from a single set of light sources 111-114 (e.g., a linear array of laser diodes) over a two-dimensional area of cylindrical print plate 132 in a manner similar to that used in conventional ROS imaging systems. Polygon mirror 120 and illuminator 110 are held in fixed relative positions by support structures (not shown) such that light sources 111-114 transmit beam pulses BP1-BP4 along fixed paths FP1-FP4 toward polygon mirror 120. Polygon mirror 120, which in the exemplary embodiment includes eight mirror facets 125-1 to 125-8, is rotated by a motor (not shown) around an axis 121, and is positioned relative to light sources 111 to 114 and to imaging cylinder 130 such that beam pulses BP1-BP4 are raster-scanned by mirror facets 125-1 to 125-8 along corresponding scan paths SP1-SP4 onto print plate 132. Specifically, fixed paths FP1-FP4 are aligned parallel to axis 121 such that beam pulses BP1-BP4 are sequentially reflected by one of facets 125-1 to 125-8 into a target region TR, which extends in a circumferential direction on print plate 132 (i.e., perpendicular to axis 131). During each raster-scan (imaging) period (i.e., while fixed paths FP1-FP4 is directed onto one of the eight mirror facets of polygon mirror 120), the reflection angle β formed by fixed paths FP1-FP4 and scan paths SP1-SP4 is defined by the instantaneous angular position of the reflecting mirror facet (e.g., facet 125-1 in FIG. 4). Because the angular position of the mirror facets continuously change as polygon mirror 120 rotates around axis 121, reflection angle β also changes, whereby beam pulses transmitted along scan paths SP1-SP4 are “swept” across a series of print plate spots that are aligned in a substantially longitudinal direction (e.g., parallel to axis 131). For example, at the beginning of the raster-scan period shown in FIG. 4, beam pulses BP1 are transmitted fixed path portion FP1 to facet 125-1 of polygon mirror 120, which reflects beam pulses BP1 along scan path SP1 such that beam pulses BP1 are first directed onto print plate spot 135-1,1. At the point depicted in FIG. 4 (i.e., a short time later), the rotation of polygon mirror 120 causes the angular position of mirror facet 125-1 to change, thereby causing scan path SP1 to align with print plate spot 135-1,3. In this manner scan path SP1 progressively travels along along print plate 132 across a series of print plate spots (i.e., in the direction of arrow S) until it is directed onto a final print plate spot 135-1,n at the end of the depicted raster-scan period. Subsequent additional rotation of polygon mirror 120 causes a next mirror facet (e.g., facet 125-2) to rotate into position to intercept fixed paths FP1-FP4, and scan paths SP1-SP4 repeat the pattern described above over a next sequential set of print plate spots.

For descriptive purposes the print plate regions swept by scan paths SP1 to SP4 during each raster-scan (imaging) period are referred to herein as a “raster-scan zones”, and are indicated by elongated shaded regions Z1 to Z4 in FIG. 4. For example, scan path SP1 is directed along raster-scan zone Z1, which coincides with the series of print plate spot including spot 135-1,3 (i.e., at the instant depicted in FIG. 4, raster-scan zone Z1 extends over print plate spots 135-1,1 to 135-1). Similarly, scan path SP2 is directed along raster-scan zone Z2, which coincides with the series of print plate spot including spot 135-2,3, scan path SP3 is directed along raster-scan zone Z3, which coincides with the series of print plate spot including spot 135-3,3, and scan path SP4 is directed along raster-scan zone Z3, which coincides with the series of print plate spot including spot 135-4,3.

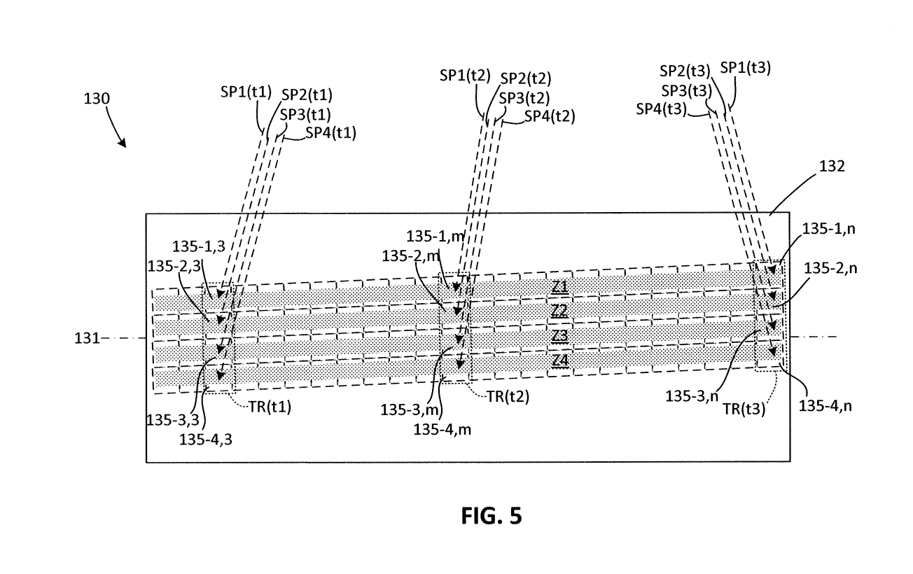

FIG. 5 is a simplified diagram depicting portions of a single raster-scan period. According to an aspect of the present embodiment, controller 140A is further coordinated with rotation of polygon mirror 120 so that beam pulses BP1 to BP4 are timed to arrive at any selected print plate spot located in associated raster-scan zone Z1 to Z4 during each raster-scan period. For example, referring to the left side of FIG. 5, at a time t1 (i.e., relatively early in the raster-scan period when fixed paths FP1 to FP4 strike the rightmost area of mirror facet 125-1 as shown in FIG. 4) scan paths SP1(t1) to SP4(t1) are directed into target region TR(t1) that covers print plate spots 135-1,3, 135-2,3, 135-3,3 and 135-4,3, which are located near the left end of print plate 132. By controlling the illuminator to generate beam pulses along all of scan paths SP1(t1) to SP4(t1) at time t1, energy doses are delivered to each of print plate spots 135-1,3, 135-2,3, 135-3,3 and 135-4,3. Similarly, at a time t2 near the middle of the same raster-scan period, scan paths SP1(t2) to SP4(t2) are directed into target region TR(t2) that covers print plate spots 135-1,m, 135-2,m, 135-3,m and 135-4,m, which are located near the middle of print plate 132. By controlling the illuminator to generate beam pulses along all of scan paths SP1(t2) to SP4(t2) at time t2, energy doses are delivered to each of print plate spots 135-1,m, 135-2,m, 135-3,m and 135-4,m. As indicated at the right side of FIG. 5, at time t3 (i.e., the end of the raster-scan period), scan paths SP1(t3) to SP4(t3) are directed into target region TR(t3) near the right end of print plate 132, so that beam pulses transmitted along scan paths SP1(t3) to SP4(t3) deliver energy doses to each of print plate spots 135-1,n, 135-2,n, 135-3,n and 135-n.

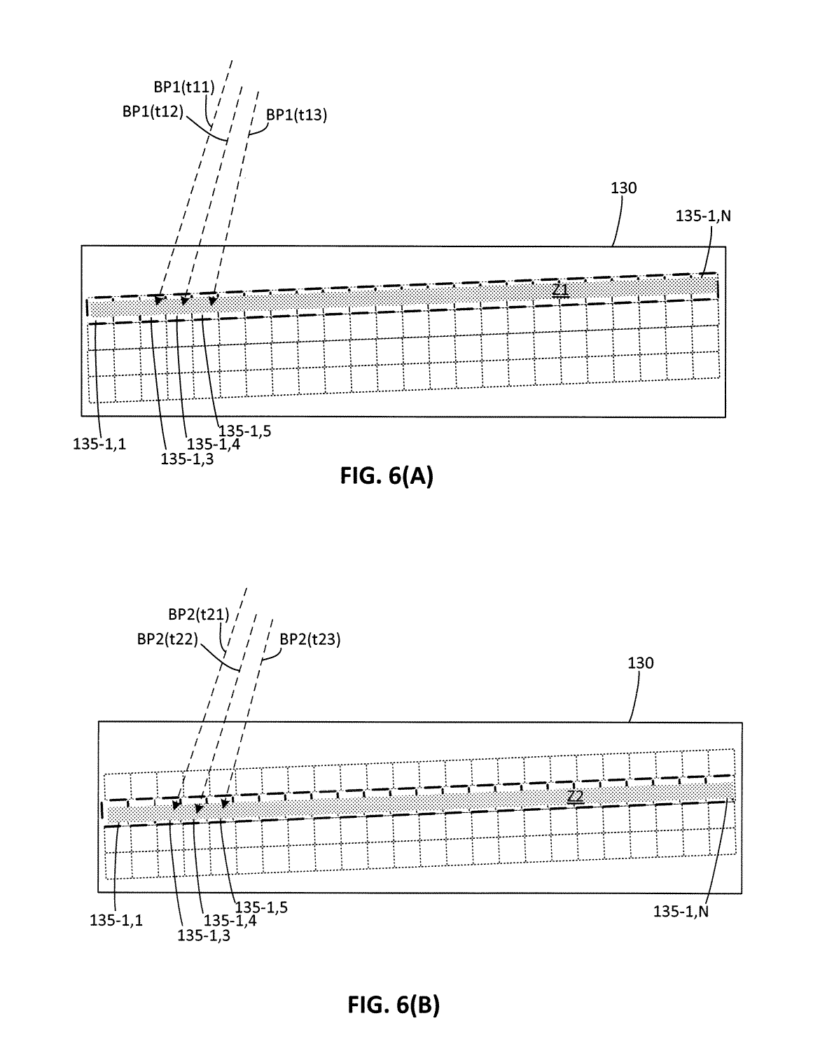

FIGS. 6(A) to 6(D) depict a portion of system 100A during a simplified example illustrating the sequential transmission of beam pulses onto linearly arranged print plate spots 135-1,1 to 135-1,n as imaging cylinder 130 rotates in the manner described above. As set forth above, controller 140A is operated in accordance with externally supplied image data to control light sources 111 to 114 in coordination with the rotation of imaging cylinder 130 and polygon mirror 120 such that multiple beam pulses are transmitted to each selected print plate spots in during each of the sequential raster-scan periods. FIGS. 6(A) to 6(D) depict an example in which beam pulses are transmitted onto print plate spots 135-1,3 to 135-1,5 during four sequential raster-scan periods in which print plate spots 135-1,1 to 135-1,n are respectively positioned in raster scan zones Z1 to Z4 by the associated rotation of imaging cylinder 130. During the first raster-scan period depicted in FIG. 6(A), as print plate spots 135-1,1 to 135-1,n pass through raster-scan zone Z1, the controller activates a first light source (e.g., light source 111 shown in FIG. 4) at times t11, t12, and t13 in coordination with rotation of the polygon mirror (not shown) such that beam pulses BP1(t11), BP1(t12), and BP1(t13) are respectively reflected by a first mirror facet (e.g., mirror 125-1, shown in FIG. 4) onto print plate spots 135-1,3, 135-1,4 and 135-1,5, respectively. During a subsequent second raster-scan period shown in FIG. 6(B), as print plate spots 135-1,1 to 135-1,n pass through raster-scan zone Z2, the controller activates a second light source (e.g., light source 112 shown in FIG. 4) at times t21, t22, and t23 in coordination with rotation of the polygon mirror such that beam pulses BP2(t21), BP2(t22), and BP2(t23) are respectively reflected by a second mirror facet (e.g., mirror 125-2, shown in FIG. 4) onto print plate spots 135-1,3, 135-1,4 and 135-1,5, respectively. Similarly, FIG. 6(C) depicts a third raster-scan period as print plate spots 135-1,1 to 135-1,n pass through raster-scan zone Z3, when the controller activates a third light source (e.g., light source 113 shown in FIG. 4) at times t31, t32, and t33 such that beam pulses BP3(t31), BP3(t32), and BP3(t33) are respectively reflected by a third mirror facet (e.g., mirror 125-3, shown in FIG. 4) onto print plate spots 135-1,3, 135-1,4 and 135-1,5, respectively. Finally, FIG. 6(D) depicts a fourth raster-scan period as print plate spots 135-1,1 to 135-1,n pass through raster-scan zone Z4, when a fourth light source (e.g., light source 114 shown in FIG. 4) is activated at times t41, t42 and t43 such that beam pulses BP4(t41), BP4(t42), and BP4(t43) are respectively reflected by a fourth mirror facet (e.g., mirror 125-4, shown in FIG. 4) onto print plate spots 135-1,3, 135-1,4 and 135-1,5, respectively. In this way, fountain solution is gradually heated up to its evaporation temperature and removed from a linear region defined by print plate spots 135-1,3, 135-1,4 and 135-1,5 due to energy doses transmitted during multiple raster-scan periods.

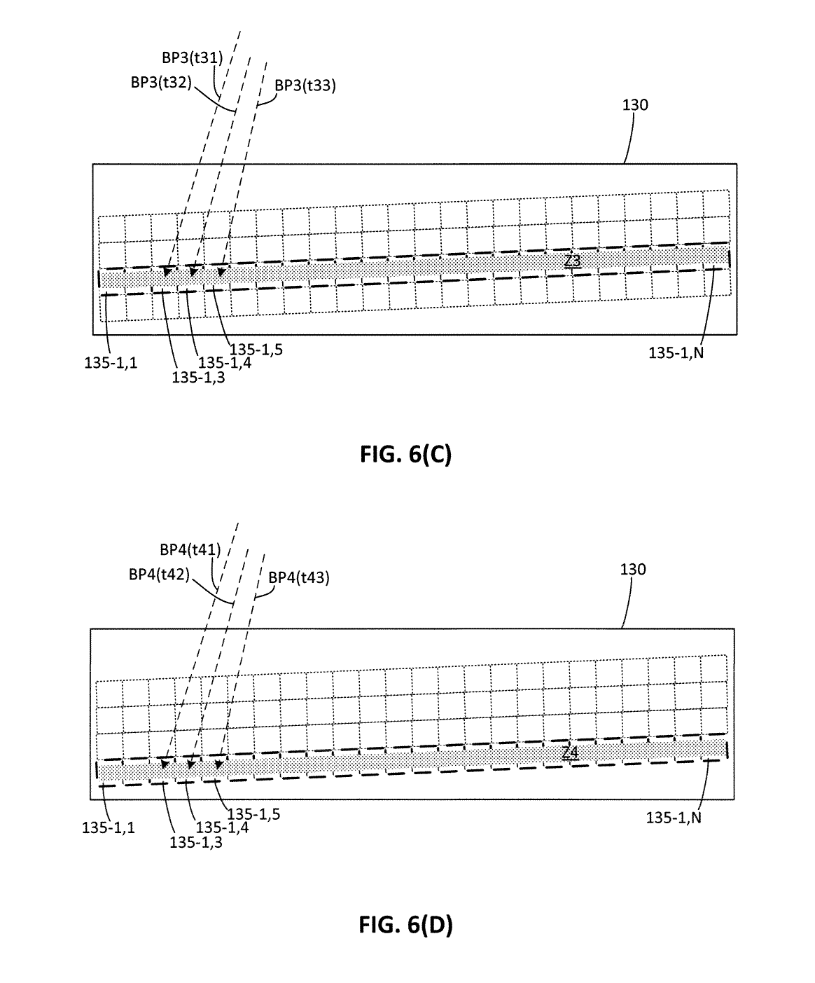

FIG. 7 is a simplified diagram showing a novel printing system 200 including conventional printing system components (e.g. such as those described with reference to the conventional system), where printing system 200 utilizes an imaging system 100B to remove fountain solution deposited onto print plate 132 by a fountain solution (FS) dampening system as imaging cylinder 130 is rotated. Consistent with the embodiments set forth above, imaging system 100B is distinguished over prior art approaches by utilizing multiple relatively low-power light sources (e.g., laser diodes) to selectively evaporate fountain solution from selected print plate spots, where exposure of the print plate is achieved by cumulative exposure to multiple parallel beams, as opposed to a single energy dose delivered by a single high-power laser. Using the example of a 24″ wide process running at 2 m/s and a 2 μm thick water-based fountain solution film (i.e. requiring 6.3 KW of energy), in a practical embodiment printing system 200 utilizes an illuminator 110B including eighteen (or more) laser diodes, each rated at 60 W output. Such arrays are commercially available, as they have found application in laser marking, machining, and other applications. According to the description above, with this practical embodiment, each selected spot on the print plate will pass through 18 raster-scan zones (i.e., instead of the four described above in the simplified embodiment). If each laser is activated at the appropriate time during each imaging period, then sufficient energy is deposited onto the selected print plate spot to heat it to a temperature at which the 2 μm thick water-based fountain solution film portion is evaporated. Analysis of a conventional print plate's thermal response has yielded an estimate thermal time constant of 10 msec. This equates to print plate travel of 5 mm at a 0.5 m/s print speed. Thus, the pitch between beams is preferably less than 5 mm to avoid excessive thermal relaxation or spreading within the print plate.

Although the present invention has been described with respect to certain specific embodiments, it will be clear to those skilled in the art that the inventive features of the present invention are applicable to other embodiments as well, all of which are intended to fall within the scope of the present invention.

1. multiple-beam imaging system comprising:
an imaging cylinder having a cylindrical print plate defining a plurality of circumferentially arranged print plate spots;
means for forming a uniform fountain solution layer on the cylindrical print plate over the plurality of circumferentially arranged print plate spots;
illuminator means for producing a plurality of beam pulses that are directed along corresponding beam paths onto a targeted group of said print plate spots disposed in an elongated target region such that each beam path is aligned with an associated said print plate spot of said targeted group;
means for controlling the illuminator means in coordination with rotation of the imaging cylinder such that during a first imaging period, a first said print plate spot of said targeted group is aligned with a first beam path and the illuminator means generates a first beam pulse along the first beam path onto the first print spot, and during a second imaging period, said first said print plate spot is aligned with a second beam path and the illuminator means generates a second beam pulse along the second beam path onto the first print spot,
wherein said means for controlling the illuminator means generates said first beam pulse such that, after said first imaging period, a fountain solution portion of said uniform fountain solution layer disposed over said first print spot increases to a first temperature, and generates the second beam pulse such that, after said second imaging period, said fountain solution portion increases to a second temperature, said second temperature being greater than said first temperature.

2. The multiple-beam imaging system of claim 1, wherein said illuminator means comprises a linear array of light sources.

3. The multiple-beam imaging system of claim 2, wherein said each light source of said linear array comprises a laser diode.

4. The multiple-beam imaging system of claim 1, further comprising means for rastering the plurality of beam pulses along corresponding parallel paths such that the plurality of beam pulses are scanned in a generally longitudinal direction along the cylindrical print plate.

5. The multiple-beam imaging system of claim 4, wherein said means for rastering comprises a polygon mirror.

6. The multiple-beam imaging system of claim 5, further comprising an optical element disposed between the illuminator means and the polygon mirror.

7. The multiple-beam imaging system claim 6, wherein said optical element comprises a collimating optical element.

8. A multiple-beam Raster Output Scanner (ROS) imaging system comprising:
an imaging cylinder having a cylindrical print plate defining a plurality of print plate spots;
means for forming a uniform fountain solution layer on the cylindrical print plate over the plurality of circumferentially arranged print plate spots;
a plurality of light sources arranged to respectively produce a plurality of beam pulses that are directed along respective corresponding fixed parallel beam paths;
a polygon mirror including a plurality of mirror facets, said polygon mirror being positioned relative to the plurality of light sources and to the imaging cylinder such that, when the polygon mirror is rotating around an axis, the plurality of beam pulses are raster-scanned by the plurality of mirror facets along corresponding scan paths onto longitudinally-arranged groups of said print plate spots respectively disposed in corresponding elongated raster-scan zones; and
means for controlling the plurality of light sources in coordination with rotation of the imaging cylinder and the polygon mirror such that, during a first raster-scan period when one or more print plate spots are disposed in a first said raster-scan zone, a first light source is activated to generate one or more first beam pulses that are respectively reflected by a first said mirror facet onto said one or more print plate spots, and during second raster-scan period when said one or more print plate spots are disposed in a second said raster-scan zone, a second light source is activated to generate one or more second beam pulses that are respectively reflected by second said mirror facet onto said one or more print plate spots,
wherein said means for controlling the plurality of light sources causes the first light source to generate said one or more first beam pulses such that, after said first raster-scan period, a fountain solution portion of said uniform fountain solution layer disposed over said one or more print plate spots increases to a first temperature, and causes the second light source to generate said one or more second beam pulses such that, after said second raster-scan period, said fountain solution portion increases to a second temperature, said second temperature being greater than said first temperature.

9. The multiple-beam ROS imaging system of claim 8, wherein each light source of said plurality of light sources comprises a laser diode.

10. The multiple-beam ROS imaging system of claim 8, wherein said polygon mirror comprises a plurality of flat mirror facets.

11. The multiple-beam ROS imaging system of claim 8, further comprising an optical element disposed between the plurality of light sources and the polygon mirror.

12. The multiple-beam ROS imaging system of claim 11, wherein said optical element comprises a collimating optical element.

13. A multiple-beam Raster Output Scanner (ROS) imaging system comprising:
a cylindrical print plate defining a plurality print plate spots;
means for forming a uniform fountain solution layer on the cylindrical print plate over the plurality of circumferentially arranged print plate spots;
a plurality of light sources arranged to respectively produce a plurality of beam pulses that are directed along respective corresponding fixed parallel beam paths;
rastering means for raster-scanning the plurality of beam pulses along corresponding scan paths onto longitudinally-arranged groups of said print plate spots respectively disposed in parallel elongated raster-scan zones; and
means for controlling the plurality of light sources in coordination with rotation of the cylindrical print plate 132 and the rastering means such that, during a first raster-scan period when one or more print plate spots are disposed in a first said raster-scan zone, a first light source is activated to generate one or more first beam pulses that are respectively raster-scanned onto said one or more print plate spots, and during a second raster-scan period when said one or more print plate spots are disposed in a second said raster-scan zone, a second light source is activated to generate one or more second beam pulses that are respectively raster-scanned onto said one or more print plate spots,
wherein said means for controlling the plurality of light sources causes the first light source to generate said one or more first beam pulses such that, after said first raster-scan period, fountain solution portions of said uniform fountain solution layer disposed over said one or more print plate spots are heated to a first temperature, and causes the second light source to generate said one or more second beam pulses such that, after said second raster-scan period, said fountain solution portions increase to a second temperature, said second temperature being greater than said first temperature.

14. The multiple-beam ROS imaging system of claim 13, wherein said plurality of light sources comprises a linear array of laser diodes.

15. The multiple-beam ROS imaging system of claim 13, wherein said rastering means comprises a polygon mirror.

16. The multiple-beam imaging system of claim 14, further comprising an optical element disposed between the plurality of light sources and the polygon mirror.

17. The multiple-beam imaging system of claim 16, wherein said optical element comprises a collimating optical element.
